(19) United States
(12) Patent Application Publication
(10) Pub. No.: US 2009/0002534 A1
(43) Pub. Date: Jan. 1, 2009

(54) Solid-state image capturing device, driving method of solid state image capturing device and electronic information device

(75) Inventor: Ichiro Baba, Hiroshima (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/215,339

(22) Filed: Jun. 26, 2008

(30) Foreign Application Priority Data
Jun. 26, 2007 (JP) 2007-168297

(51) Int. Cl. H04N 5/335

(52) U.S. Cl. 348/302; 348/E05.091

(57) ABSTRACT

A solid-state image capturing device for capturing a subject to generate and output an image signal is provided, in which a predetermined number of transfer gates applied with different driving signals are arranged adjacent to respective pixel sections, so that each light receiving section and the predetermined number of transfer gates in the vertical transfer section form each pixel, and a driving signal for a transfer gate is applied to the transfer gates in such a manner that adjacent pixels are included in a cycle of an arrangement pattern for transfer gates and accumulated charges in the adjacent pixels are simultaneously read out to a single transfer packet formed in a vertical transfer section.

This Nonprovisional Application claims priority under 35 U.S.C. §119(a) on Patent Application No. 2007-168297 filed in Japan on Jun. 26, 2007, the entire contents of which are hereby incorporated by reference.

### BACKGROUND OF THE INVENTION

1. Field of the Invention

The present invention relates to a solid-state image capturing device, a driving method of the solid-state image capturing device, and an electronic information device, and more specifically to a solid-state image capturing device suitable for applying for an image sensor that can select and read information on all the pixels to output an image signal, a driving method of the solid-state image capturing device, and an electronic information device.

2. Description of the Related Art

As the performance of digital still cameras and monitoring cameras advances, a variety of techniques have been proposed to widen the dynamic range, which is a main performance of the aforementioned cameras.

For example, Reference 1 proposes a method for widening the dynamic range, which obtains both a bright image capturing screen whose image is obtained by having a longer exposure time and a dark image capturing screen whose image is obtained by having a shorter exposure time and performs an image combining process on the two screens so as to obtain an image signal that has a wide dynamic range.

In addition, as for an actual driving method of a solid-state image capturing device for obtaining an image signal having a wide dynamic range as described above, Reference 2 discloses a method to read out a signal change of a bright image capturing screen whose image is obtained by having a longer exposure time and a signal change of a dark image capturing screen whose image is obtained by having a shorter exposure time successively in separate transfer packets.

FIG. 4 is a diagram explaining a readout of an accumulated charge by the driving method disclosed in Reference 2 described above, schematically showing a pixel arrangement and a transfer packet in a vertical direction in an image capturing area of a solid-state image capturing device. Note that T denotes a time axis in FIG. 4.

In an image capturing area 2, photodiodes 21 to 28 are arranged in this order in one row along a vertical direction of the image capturing screen as light receiving sections that perform photoelectric conversion on incident light reflected from a subject. Along a row (PD row) 20 including the photodiodes 21 to 28, transfer gate electrodes (simply referred to as transfer gates hereinafter) are arranged to read out accumulated charge from the photodiodes to transfer the accumulated charge in a vertical direction. The transfer gates configures a vertical CCD 200 and forms a transfer packet Tp for transferring a signal charge that is read out from the photodiodes.

More specifically, the photodiodes 21, 22, 23, and 24 described above are arranged with color filters to form a Cy (cyan) pixel P21, a G (green) pixel P22, a Cy (cyan) pixel P23, and an Mg (magenta) pixel P24 respectively. In addition, first to fourth transfer gates 211 to 214 are provided for the photodiode 21 to form the Cy pixel P21, and the first transfer gate 211 also serves as a readout gate for reading out the charge accumulated in the photodiode 21 to the vertical CCD 200. First to fourth transfer gates 221 to 224 are provided for the photodiode 22 to form the G pixel P22 described above, and the first transfer gate 221 also serves as a readout gate for reading out the charge accumulated in the photodiode 22 to the vertical CCD 200. First to fourth transfer gates 231 to 234 described above are provided for the photodiode 23 to form the Cy pixel P23, and the first transfer gate 231 also serves as a readout gate for reading out the charge accumulated in the photodiode 23 to the vertical CCD 200. First to fourth transfer gates 241 to 244 for forming the Mg pixel P24 described above are provided for the photodiode 24 that forms the Mg pixel P24, and the first transfer gate 241 also serves as a readout gate for reading out the charge accumulated in the photodiode 24 to the vertical CCD 200.

Herein, second to fourth driving signals (also referred to CCD driving signal hereinafter) ΦV2 to ΦV4, which are applied to the second to fourth transfer gates of each pixel, are the same for the Cy pixel, G pixel and Mg pixel. However, the first driving signal ΦV1B, which is applied to the first transfer gate 211 coupled with the Cy pixel, and the first driving signal ΦV1A, which is applied to the first transfer gate 221 or 241 coupled with the G pixel or the Mg pixel, are different from each other in terms of the time for generating a readout pulse to read out the accumulated charge from the photodiodes. Therefore, eight transfer gates, which are associated with adjacent pixels, form a transfer gate structural cycle, namely one vertical CCD cell. Two adjacent pixels exist in a structural cycle Pgc of the transfer gates. More specifically, the Cy pixel P21 and the G pixel P22 exist in a transfer gate structural cycle Pgc which is formed by the eight transfer gates 211 to 214 and 221 to 224 as described above, and the Cy pixel P23 and the Mg pixel P24 exist in a transfer gate structural cycle which is formed by the eight transfer gates 231 to 234 and 241 to 244 as described above.

In addition, photodiodes 25, 26, 27, and 28, which serve as the light receiving sections described above, are arranged with color filters to form Cy (cyan) pixel P25, G (green) pixel P26, Cy (cyan) pixel P27, and Mg (magenta) pixel P28, respectively. Similar to the photodiodes 21, 22, 23 and 24 described above, first to fourth transfer gates, which are 251 to 254, 261 to 264, 271 to 274, 281 to 284, respectively, are provided for these photodiodes. Further, eight transfer gates, which are coupled with adjacent pixels, form one vertical CCD cell, namely a transfer gate structural cycle. Two adjacent pixels exist in a structural cycle Pgc of the transfer gates. More specifically, the Cy pixel P25 and the G pixel P26 exist in a transfer gate structural cycle Pgc, which is formed by the eight transfer gates 251 to 254 and 261 to 264 as described above, and the Cy pixel P27 and the Mg pixel P28 exist in a transfer gate structural cycle which is formed by the eight transfer gates 271 to 274 and 281 to 284 described above.

Note that FIG. 4 shows only eight pixels arranged in a vertical direction for the reason of simplicity and that an actual solid-state image capturing device includes a plurality of such pixels (also referred to light receiving section pixels hereinafter) arranged in a matrix, and one end of each of a plurality of vertical CCDs arranged along respective pixel rows is connected to a horizontal CCD 200a.

Next, an operation will be described.

FIG. 5 is a time chart explaining an operation to obtain a bright image capturing screen whose image is obtained by having a longer exposure time and a dark image capturing screen whose image is obtained by having a shorter exposure time in the solid-state image capturing device described above. FIG. 5 shows a readout and transfer operation of an accumulated charge in an odd number field (ODD) according to a field readout method. Further, FIG. 6 shows an enlarged operational waveform in the timing chart shown in FIG. 5 during the readout of the accumulated charge of an image capturing screen having a shorter exposure time.

Note that FIG. 5 shows operational waveforms of a vertical blanking interval Vbk and vertical imaging interval before and after the vertical blanking interval Vbk for the sake of simplicity and that HD denotes a horizontal synchronization signal, VD denotes a vertical synchronization signal, VTp denotes a vertical transfer pulse, Hs denotes a horizontal scanning interval (horizontal interval cycle), Hbk denotes a horizontal blanking interval, and Hvd denotes a horizontal imaging interval.

When light from a subject enters the solid-state image capturing device described above, photoelectric conversion on the incident light and accumulation of charges generated by the photoelectric conversion are performed in each of the photodiodes 21 to 28 serving as a light receiving section. Subsequently, the accumulated electric charges (accumulated charges) are read out to the vertical CCD 200, and the accumulated charges read out by the vertical CCD 200 are transferred to the horizontal CCD 200a by the vertical CCD. Further, the accumulated charges are transferred from the horizontal CCD 200a to a charge detection section 200b during the horizontal interval cycle, and the accumulated charges are converted into a voltage signal in the charge detection section 200b and are output as an output signal OS.

As explained in more detail herein, the photodiodes are repeatedly reset by shutter pulses Sp until a time is earlier than a time for reading out the accumulated charges by a predetermined time (accumulation time). Accumulated charges which are accumulated from the time when a series of the shutter pulses Sp end to the time when readout pulses LcB of a first CCD driving signal applied to the first transfer gate end, in other words, accumulated charges in accordance with the shutter speed corresponding to this electric charge accumulation time, are read out to the vertical CCD 200.

More specifically, in the initial state (time tj0), that is, a state immediately before the readout of a field, the same number of empty transfer packets TP, which are formed by the first to fourth CCD driving signals described above, are arranged as the plurality of light receiving section pixels (i.e., the plurality of light receiving section pixels are arranged in the repetitive order of a Cy pixel, a G pixel, a Cy pixel and an MG pixel in a vertical direction). In this state, each of the light receiving section pixels is in a state where a signal charge obtained during a longer exposure time is accumulated.

Next, at time tj1, accumulated charges of the Cy pixels P21, P23, P25 and P27, which are, signal charges accumulated during the accumulation time LTB, are read out to the transfer packet TP1 corresponding to the Cy pixels when a readout pulse LcB of the first CCD driving signal ΦV1B is generated.

Subsequently, during time tj2 to time tj5, the signal charges read out to the transfer packet TP1 described above are transferred by one pixel in a vertical direction by the first to fourth CCD driving signals ΦV1A, ΦV1B and ΦV2 to ΦV4.

Next, at time tj5, when a readout pulse LcA of the first CCD driving signal ΦV1A is generated, accumulated charges of the G pixel P22, the Mg pixel P24, the G pixel P26 and the Mg pixel P28, that is, signal charges G and Mg accumulated during the accumulation time LTA, are read out to the transfer packet TP1, in which signal charges from the Cy pixel at the time tj1 described above are read out.

In this state, transfer packets TP1, in which signal charges that are an equivalent of two pixels obtained during a longer exposure time are added together and exist, and empty transfer packets TP2 are alternatively arranged in the corresponding pixels.

Thereafter, awaiting period continues for awhile. During the waiting period, the photodiodes are repeatedly reset by the shutter pulses Sp until time tOFD that is earlier than a time for reading out the accumulated charges by a predetermined time (accumulation time). Signal charges obtained during the shorter exposure time are accumulated during the accumulation time.

At time tj6, when a readout pulse ScB of the first CCD driving signal ΦV1B is generated, accumulated charges of the Cy pixels P21, P23, P25 and P27, that is, signal charges Cy′ accumulated during the accumulation time STB, are read out to a transfer packet TP2 corresponding to the pixels.

Subsequently, during time tj7 to time tj10, the signal charges readout to the transfer packet TP2 described above are transferred by one pixel in a vertical direction by the first to fourth CCD driving signals ΦV1A, ΦV1B and ΦV2 to ΦV4.

Next, at time tj10, when a readout pulse ScA of the first CCD driving signal ΦV1A is generated, accumulated charges of the G pixel P22, the Mg pixel P24, the G pixel P26 and the Mg pixel P28, that is, signal charges G′ and Mg′ accumulated during the accumulation time STA, are read out to the transfer packet TP2, in which signal charges from the Cy pixel at time tj6 as described above are read out.

In this state, transfer packets TP1, in which signal charges that are an equivalent of two pixels obtained during a longer exposure time are added together and exist, and transfer packets TP2, in which signal charges that are an equivalent of two pixels obtained during a shorter exposure time are added together and exist, are alternatively arranged in the corresponding pixels.

As described above, two kinds of signal charges, signal charges obtained during a longer exposure and signal charges obtained during a shorter exposure, which are stored in different transfer packets, are successively read out and are synthesized by signal processing, thereby obtaining an image having a wide dynamic range.

Reference 1: Japanese Laid-Open Publication No. 5-176233

Reference 2: Japanese Laid-Open Publication No. 6-113207

### SUMMARY OF THE INVENTION

In the conventional driving method, the following problems would occur as an OFD shutter speed increases.

First, as a fundamental principle of the OFD shutter, an exposure time of an image capturing device controlled by an OFD shutter operation is defined as a period from a time tOFD (refer to FIG. 6) when a OFD shutter pulse ends to a time when a readout pulse for reading out accumulated charges from light receiving section pixels to the transfer packets ends, as described above. If the conventional driving technique is adopted in this case, a time lag Terr occurs between the time STB and the time STA, the STB being from the time tOFD when the OFD shutter pulse ends to the time tΦV1B when the readout pulse SCB of the first CCD driving signal ΦV1B ends, and the time STA being from the time tOFD when the OFD shutter pulse ends to the time tΦV1A when the readout pulse ScA of the first CCD driving signal ΦV1A ends. When an exposure time is relatively long, such a time lag does not affect the picture quality significantly. However, as the OFD shutter speed advances, that is, as the exposure time becomes shorter, influences due to the aforementioned time lag cannot be ignored.

Specifically, as shown in FIG. 6, an image signal obtained by the gate readout by the first CCD driving signal ΦV1A has STA=tOFD−tΦv1A in an exposure time, and an image signal obtained by the gate readout by the first CCD driving signal ΦV1B has STB=tOFD−tΦv1B in an exposure time. The more the ratio of the error Terr (=tΦv1A−tΦv1B) of the exposure time to the exposure time increases as compared with STA and STB of signal charges read out by the first CCD driving signal as described above increases, the more deterioration, color shift, line crawl and the like would occur in a picture.

The present invention is intended to solve the aforementioned problems. The objective of the present invention is to provide a solid-state image capturing device capable of easily obtaining a good image signal having a wide dynamic range without picture deterioration upon a fast speed operation of the OFD shutter, and a driving method of the solid-state image capturing device.

A solid-state image capturing device for capturing a subject to generate and output an image signal according to the present invention includes a plurality of light receiving sections for performing a photoelectric conversion on incident light from the subject and accumulating signal charges obtained by the photoelectric conversion, the plurality of light receiving section being arranged in a matrix; and a vertical transfer section including a plurality of transfer gates arranged along a row direction of the plurality of light receiving section, the vertical transfer section reading out the signal charges accumulated in the light receiving section and transferring the signal charges in a row direction, in which a predetermined number of transfer gates applied with different driving signals are arranged adjacent to respective pixel sections, so that each light receiving section and the predetermined number of transfer gates in the vertical transfer section form each pixel; and in which a driving signal for a transfer gate is applied to the transfer gates in such a manner that adjacent pixels are included in a cycle of an arrangement pattern for transfer gates and accumulated charges in the adjacent pixels are simultaneously read out to a single transfer packet formed in a vertical transfer section.

A solid-state image capturing device according to the present invention further includes a horizontal transfer section for receiving a signal charge transferred from the vertical transfer section in a row direction and outputting the signal charge from the vertical transfer section for every horizontal interval cycle.

In a solid-state image capturing device according to the present invention, two or more transfer packets are formed within a cycle of an arrangement pattern of the transfer gates of the vertical transfer section.

In a solid-state image capturing device according to the present invention, an operation to read out accumulated charges from adjacent pixels included in a cycle of the arrangement pattern of the transfer gates to the single transfer packet is performed twice within one field period.

In a solid-state image capturing device according to the present invention, at least an operation to read out accumulated charges obtained during a shorter exposure time between the operations to read out accumulated charges performed twice within the one field period is performed simultaneously between the adjacent pixels.

In a solid-state image capturing device according to the present invention, an operation to read out accumulated charges from adjacent pixels included in a cycle of the arrangement pattern of the transfer gates to the single transfer packet is performed three times or more within one field period.

A driving method of a solid-state image capturing device for capturing a subject to generate and output an image signal according to the present invention includes a plurality of light receiving section for performing a photoelectric conversion on incident light from the subject and accumulating signal charges obtained by the photoelectric conversion, the light receiving section being arranged in a matrix; and a vertical transfer section including a plurality of transfer gates arranged along a row direction of the plurality of light receiving section, the vertical transfer section reading out the signal charges accumulated in the light receiving section and transferring the signal charges in a row direction, in which a predetermined number of transfer gates applied with different driving signals are arranged adjacent to respective pixel sections, so that each light receiving section and the predetermined number of transfer gates in the vertical transfer section form each pixel; and the method including the step of applying a driving signal for a transfer gate to the transfer gates in such a manner that adjacent pixels in the solid-state image capturing device are included in a cycle of an arrangement pattern for transfer gates and accumulated charges in the adjacent pixels are simultaneously read out to a single transfer packet formed in a vertical transfer section.

In a driving method of a solid-state image capturing device according to the present invention, the solid-state image capturing device includes a horizontal transfer section for receiving a signal charge transferred from the vertical transfer section in a row direction and outputting the signal charge from the vertical transfer section for every horizontal interval cycle.

In a driving method of a solid-state image capturing device according to the present invention, two or more transfer packets are formed within a cycle of an arrangement pattern of the transfer gates of the vertical transfer section.

In a driving method of a solid-state image capturing device according to the present invention, an operation to read out accumulated charges from adjacent pixels included in a cycle of the arrangement pattern of the transfer gates to the single transfer packet is performed twice within one field period.

In a driving method of a solid-state image capturing device according to the present invention, at least an operation to read out accumulated charges obtained during a shorter exposure time between the operations to read out accumulated charges performed twice within the one field period is performed simultaneously between the adjacent pixels.

In a driving method of a solid-state image capturing device according to the present invention, an operation to read out accumulated charges from adjacent pixels included in a cycle of the arrangement pattern of the transfer gates to the single transfer packet is performed three times or more within one field period.

An electronic information device according to the present invention uses the solid-state image capturing device according to the present invention as an image capturing section.

The functions of the present invention having the structures described above will be described hereinafter.

According to the present invention, a driving signal for a transfer gate is applied to the transfer gates in such a manner that adjacent pixels are included in a cycle of an arrangement pattern for transfer gates and accumulated charges in the adjacent pixels are simultaneously read out to a single transfer packet formed in a vertical transfer section, so that the timing to read out the accumulated charges in the adjacent pixels to the transfer packets does not shift. Therefore, no matter how fast the OFD shutter speed is, the deterioration in an image due to the time lag of exposure times between adjacent pixels is avoided. As a result, even when a wide dynamic driving is performed for the solid-state image capturing device, which obtains both a captured image obtained during a longer exposure time and a captured image obtained during a shorter exposure time, the image deterioration in a captured image obtained during a shorter exposure time is avoided and a good image signal having a wide dynamic range is easily obtained.

According to the present invention with the structure described above, the deterioration, such as color shift and line crawl, can be prevented in an image which becomes noticeable as the OFD shutter speed increases, and a good image signal can be obtained, thereby a high performance for a digital still camera and a monitoring camera can be realized.

These and other advantages of the present invention will become apparent to those skilled in the art upon reading and understanding the following detailed description with reference to the accompanying figures.

### BRIEF DESCRIPTION OF THE DRAWINGS

FIG. 1 is a diagram describing an example of a pixel structure and driving of a solid-state image capturing device according to Embodiment 1 of the present invention, schematically showing a pixel arrangement and transfer packets in a vertical direction in an image capturing area of the solid-state image capturing device.

FIG. 2 is a signal waveform diagram explaining an operation timing performed by the solid-state image capturing device according to Embodiment 1, showing a readout and transfer operation of an accumulated charge in an odd number field (ODD) according to a field readout method.

FIG. 3 is a diagram showing an enlarged operational waveform of a signal waveform shown in FIG. 2 during a readout of accumulated charges obtained by a shorter exposure.

FIG. 4 is a diagram explaining a readout of an accumulated charge by the driving method disclosed in Reference 2, schematically showing an example of a pixel arrangement and a transfer packet in a vertical direction in an image capturing area of a solid-state image capturing device.

FIG. 5 is a time chart explaining an operation performed by a conventional solid-state image capturing device according to Reference 2 described above. FIG. 5 shows an operation for obtaining a bright image capturing screen whose image is obtained by having a longer exposure time and a dark image capturing screen whose image is obtained by having a shorter exposure time.

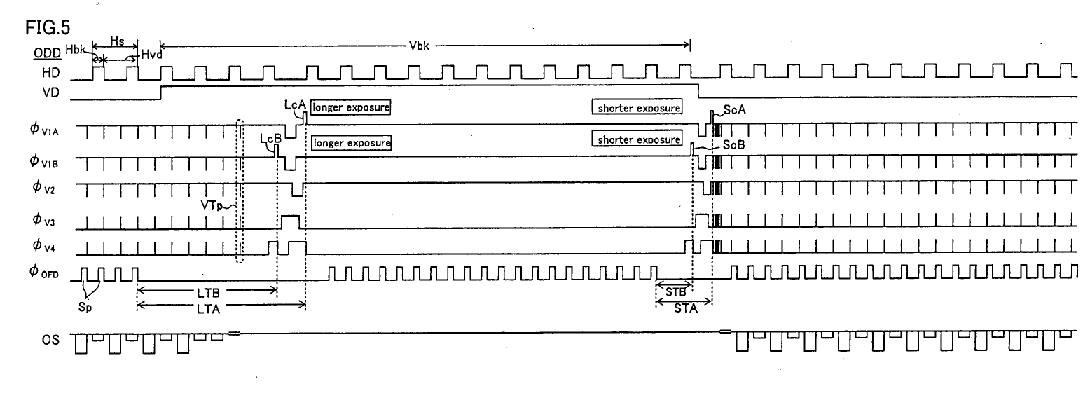

FIG. 6 is a diagram showing an enlarged operational waveform of a signal waveform shown in FIG. 5 during the readout of the accumulated charges obtained by a shorter exposure.

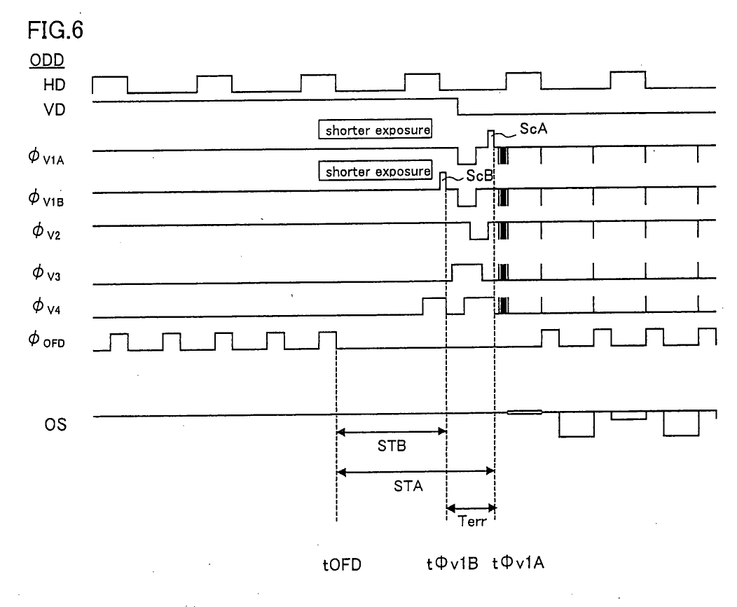

FIG. 7 is a block diagram showing an exemplary diagrammatic structure of an electric information device of Embodiment 2 of the present invention using the solid-state image capturing apparatus according to Embodiment 1 as an image capturing section.

1 image capturing area
10 photodiode row (PD row)
11 to 18 pixel
100 vertical CCD
111 to 114, 121 to 124, 131 to 134, 141 to 144, 151 to 154, 161 to 164, 171 to 174, 181 to 184 transfer gate
P11 to P18 pixel
Hbk horizontal blanking interval
HD horizontal synchronization signal
Hs horizontal scanning interval
Hvd horizontal imaging interval
LcA1, LcA4, ScA1, ScA4 readout pulse
LTA, STA accumulation time
Vbk vertical blanking interval
VD vertical synchronization signal
ΦV1A, ΦV1B, ΦV2, ΦV3, ΦV4A, ΦV4B CCD driving signal

### DESCRIPTION OF THE PREFERRED EMBODIMENTS

Hereinafter, embodiments of the present invention will be described.

### Embodiment 1

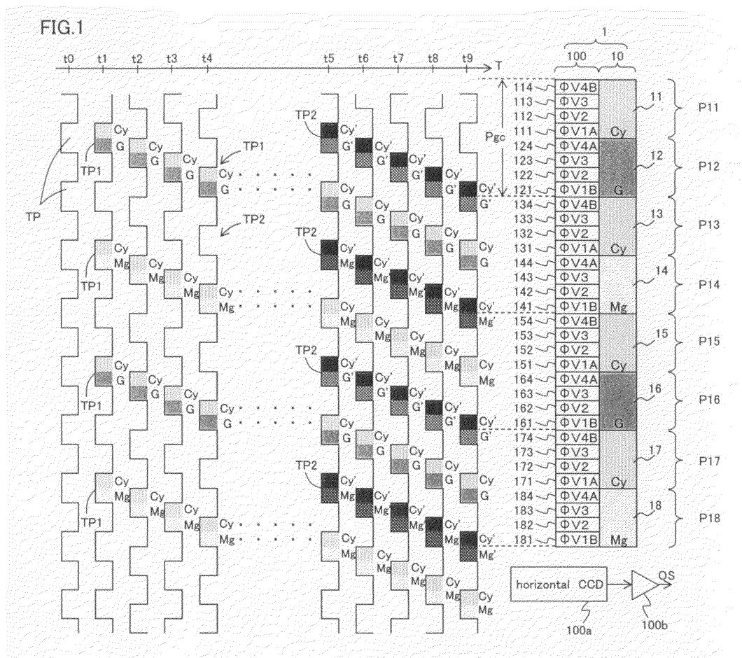

FIG. 1 is a diagram describing a solid-state image capturing device according to Embodiment 1 of the present invention, schematically showing a pixel arrangement and transfer packets in a vertical direction in an image capturing area of the solid-state image capturing device. Note that T denotes a time axis in the figure.

In an image capturing area 100 of the solid-state image capturing device according to Embodiment 1, photodiodes 11 to 18 are arranged in this order in one row along a vertical direction of the captured image as light receiving sections that perform photoelectric conversion on incident light reflected from a subject. Along a row (PD row) 10 including the photodiodes 11 to 18, transfer gate electrodes (simply referred to as transfer gates hereinafter) are arranged to read out accumulated charge from the photodiodes to transfer the accumulated charge in a vertical direction. The transfer gates configures a vertical CCD 100 and forms a transfer packet Tp for transferring in a vertical direction a signal charge that is read out from the photodiodes.

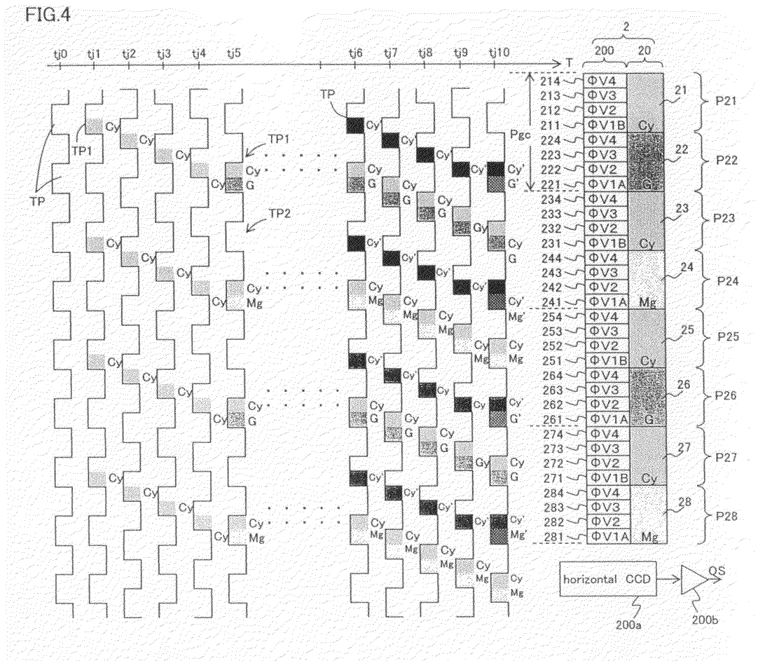

More specifically, the photodiodes 11 to 18 described above are the same as the conventional photodiodes 21 to 28 shown in FIG. 4 and are arranged with color filters respectively to form a Cy (cyan) pixel P11, a G (green) pixel P12, a Cy (cyan) pixel P13, an Mg (magenta) pixel P14, a Cy (cyan) pixel P15, a G (green) pixel P16, a Cy (cyan) pixel P17, and an Mg (magenta) pixel P18 respectively.

Further, in Embodiment 1, first to fourth transfer gates 111 to 114 are provided for the photodiode 11 to form the Cy pixel P11, and the first transfer gate 111 also serves as a readout gate for reading out the charge accumulated in the photodiode 11 to the vertical CCD 100. First to fourth transfer gates 121 to 124 are provided for the photodiode 12 to form the G pixel P12 described above, and the fourth transfer gate 124, which is adjacent to the first transfer gate 111 of the Cy pixel P11 described above, also serves as a readout gate for reading out the charge accumulated in the photodiode 12 to the vertical CCD 100. First to fourth transfer gates 131 to 134 are provided for the photodiode 13 to form the Cy pixel P13 described above, and the first transfer gate 131 also serves as a readout gate for reading out the charge accumulated in the photodiode 13 to the vertical CCD 100. First to fourth transfer gates 141 to 144 are provided for the photodiode 14 to form the Mg pixel P14 described above, and the fourth transfer gate 144, which is adjacent to the first transfer gate 131 of the Cy pixel P13 described above, also serves as a readout gate for reading out the charge accumulated in the photodiode 14 to the vertical CCD 100.

Herein, second and third driving signals (also referred to CCD driving signal hereinafter) ΦV2 and ΦV3 that are applied to the second and third transfer gates are the same for the corresponding Cy pixel, the corresponding G pixel and the corresponding Mg pixel. In addition, first driving signal (also referred to CCD driving signal hereinafter) ΦV1B applied to the first transfer gate and fourth driving signal (also referred to CCD driving signal hereinafter) ΦV4A applied to the fourth transfer gate are the same for the corresponding G pixel and the corresponding Mg pixel.

Further, the first driving signal ΦV1B applied to the first transfer gate of the G pixel and the Mg pixel and the first driving signal ΦV1A applied to the first transfer gate of the Cy pixel are different from each other in that the first driving signal ΦV1B does not include a readout pulse and the first driving signal ΦV1A includes a readout pulse ScA1. Further, the fourth driving signal ΦV4A applied to the fourth transfer gate of the G pixel and the Mg pixel and the fourth driving signal ΦV4B applied to the fourth transfer gate of the Cy pixel are different from each other in that the fourth driving signal ΦV4A includes a readout pulse ScA4 and the fourth driving signal ΦV4B does not include a readout pulse.

Moreover, eight transfer gates associated with two adjacent pixels form one vertical CCD cell, and two adjacent pixels exist in a structural cycle Pgc of the transfer gates. More specifically, the Cy pixel P11 and the G pixel P12 exist in a transfer gate structural cycle formed by the eight transfer gates 111 to 114 and 121 to 124, and the Cy pixel P13 and the Mg pixel P14 exist in a transfer gate structural cycle formed by the eight transfer gates 131 to 134 and 141 to 144.

In addition, similar to the photodiodes 11, 12, 13 and 14 described above, first to fourth transfer gates 151 to 154, 161 to 164, 171 to 174, and 181 to 184 are provided for the photodiodes 15, 16, 17 and 18 described above.

The first to fourth transfer gates 151 to 154 are provided for the photodiode 15 to form the Cy pixel P15, and the first transfer gate 151 also serves as a readout gate for reading out the charge accumulated in the photodiode 15 to the vertical CCD 100. The first to fourth transfer gates 161 to 164 are provided for the photodiode 16 to form the G pixel P16 described above, and the fourth transfer gate 164 adjacent to the first transfer gate 151 of the Cy pixel P15 described above also serves as a readout gate for reading out the charge accumulated in the photodiode 16 to the vertical CCD 100.

The first to fourth transfer gates 171 to 174 are provided for the photodiode 17 to form the Cy pixel P17 described above, and the first transfer gate 171 also serves as a readout gate for reading out the charge accumulated in the photodiode 17 to the vertical CCD 100. The first to fourth transfer gates 181 to 184 are provided for the photodiode 18 to form the Mg pixel P18 described above, and the fourth transfer gate 184 adjacent to the first transfer gate 171 of the Cy pixel P17 described above also serves as a readout gate for reading out the charge accumulated in the photodiode 18 to the vertical CCD 100.

Herein, second and third driving signals (also referred to CCD driving signal hereinafter) ΦV2 and ΦV3 applied to the second and third transfer gates are the same for the corresponding Cy pixel, the corresponding G pixel and the corresponding Mg pixel. In addition, first driving signal (also referred to CCD driving signal hereinafter) ΦV1B applied to the first transfer gate and fourth driving signal (also referred to CCD driving signal hereinafter) ΦV4A applied to the fourth transfer gate are the same for the corresponding G pixel and the corresponding Mg pixel.

Further, the first driving signal ΦV1B applied to the first transfer gate of the G pixel and the Mg pixel and the first driving signal ΦV1A applied to the first transfer gate of the Cy pixel are different from each other in that the first driving signal ΦV1B does not include a readout pulse and the first driving signal ΦV1A includes a readout pulse ScA1. Further, the fourth driving signal ΦV4A applied to the fourth transfer gate of the G pixel and the Mg pixel and the fourth driving signal ΦV4B applied to the fourth transfer gate of the Cy pixel are different from each other in that the fourth driving signal ΦV4A includes a readout pulse ScA4 and the fourth driving signal ΦV4B does not include a readout pulse.

Moreover, eight transfer gates associated with two adjacent pixels form one vertical CCD cell, and two adjacent pixels exist in a structural cycle Pgc of the transfer gates. More specifically, the Cy pixel P15 and the G pixel P16 exist in a transfer gate structural cycle formed by the eight transfer gates 151 to 154 and 161 to 164, and the Cy pixel P17 and the Mg pixel P18 exist in a transfer gate structural cycle formed of the eight transfer gates 171 to 174 and 181 to 184.

Note that FIG. 1 shows only eight pixels arranged in a vertical direction for the reason of simplicity and that an actual solid-state image capturing device includes a plurality of such pixels arranged in a matrix, and one end of each vertical CCDs is connected to a horizontal CCD 100a.

Next, an operation will be described.

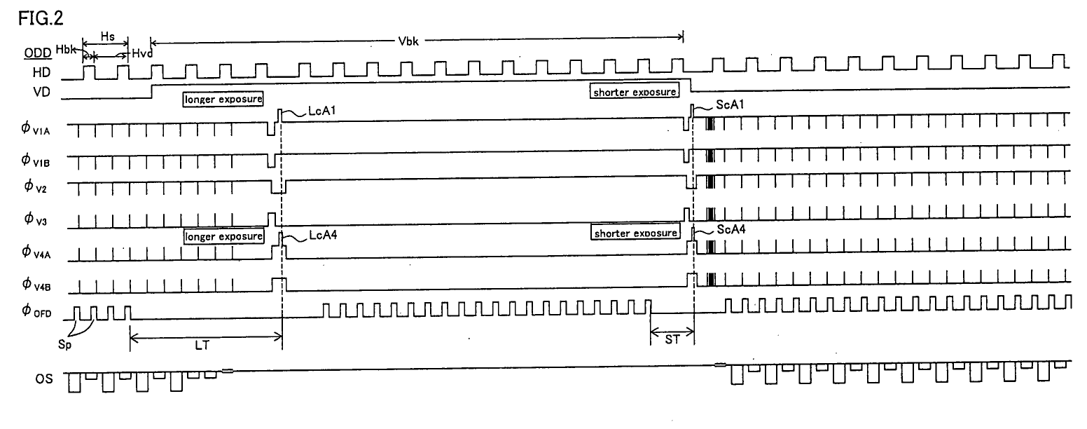

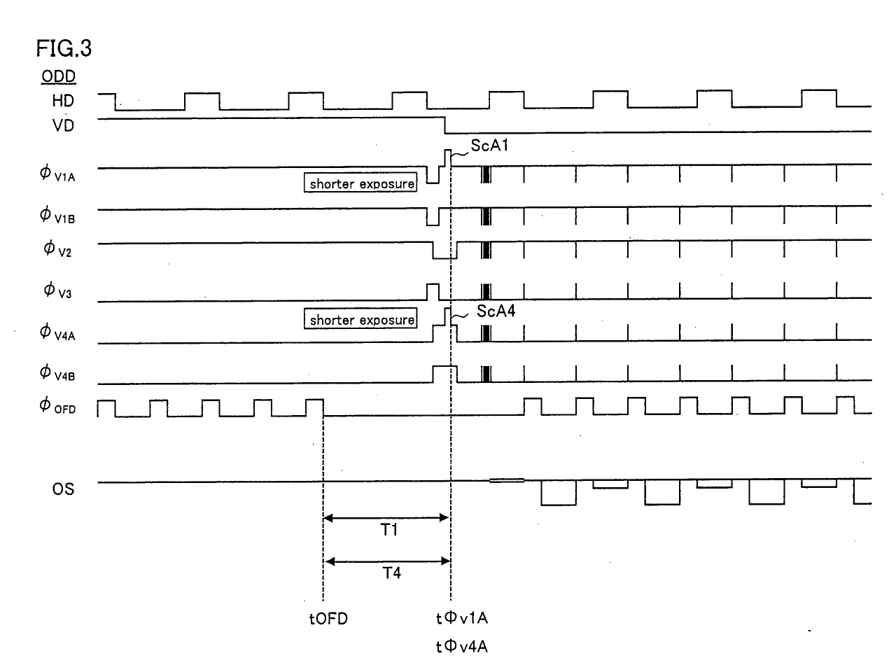

FIG. 2 is a time chart explaining an operation to obtain an image capturing screen whose image is obtained by having a longer exposure time and an image capturing screen whose image is obtained by having a shorter exposure time in the solid-state image capturing device described above. FIG. 3 shows a readout and transfer operation of an accumulated charge in an odd number field (ODD) according to a field readout method. Further, FIG. 3 shows an enlarged operational waveform while obtaining an image capturing screen whose image is obtained by having a shorter exposure time described in FIG. 2.

Note that FIG. 2 shows operational waveforms of a vertical blanking interval Vbk and vertical imaging interval before and after the vertical blanking interval Vbk for the reason of simplicity and that HD denotes a horizontal synchronization signal, VD denotes a vertical synchronization signal, VTp denotes a vertical transfer pulse, Hs denotes a horizontal scanning interval, Hbk denotes a horizontal blanking interval, and Hvd denotes a horizontal imaging interval. In addition, although FIG. 2 does not show a transfer operation of an accumulated charge in an even number field (EVEN), it is needless to say that the transfer operation of an accumulated charge in an even number field (EVEN) is the same as the transfer operation of an accumulated charge in the odd number field (ODD).

When light reflected from a subject enters the solid-state image capturing device described above, photoelectric conversion on the incident light and accumulation of charges generated by the photoelectric conversion are performed in the photodiodes 11 to 18. Subsequently, the accumulated electric charges (accumulated charges) are read out to the vertical CCD 100, and the accumulated charges read out by the vertical CCD 100 are transferred to the horizontal CCD 10a by the vertical CCD. Further, the accumulated charges are transferred from the horizontal CCD 10a to a charge detection section 100b during the horizontal interval cycle, that is, every horizontal scanning interval, and the accumulated charges are converted into a voltage signal in the charge detection section 100b and are output as an output signal OS.

As explained in more detail herein, the photodiodes 11 to 18 are repeatedly reset by shutter pulses Sp until a time earlier than a timing for reading out the accumulated charges by a predetermined time (accumulation time).

In photodiodes 11, 13, 15 and 17, accumulated charges which are accumulated from the time when a series of the shutter pulses Sp end to the time when readout pulses LcA1 or ScA1 of the first CCD driving signal ΦV1A applied to the first transfer gate end, in other words, accumulated charges in accordance with the shutter speed corresponding to this electric charge accumulation time, are read out to the vertical CCD 100.

In addition, in photodiodes 12, 14, 16 and 18, accumulated charges which are accumulated from the time when a series of the shutter pulses Sp end to the time when readout pulses LcA4 or ScA4 of the fourth CCD driving signal ΦV4A applied to the fourth transfer gate end, in other words, accumulated charges in accordance with the shutter speed corresponding to this electric charge accumulation time, are read out to the vertical CCD 100.

More specifically, in the initial state (time t0), that is, a state immediately before the readout of a field, the same number of empty transfer packets TP, which are formed by the first to fourth CCD driving signals described above, are arranged as the plurality of light receiving section pixels (i.e., the plurality of light receiving section pixels are arranged in the repetitive order of a Cy pixel, a G pixel, a Cy pixel and an MG pixel in a vertical direction). In this state, the transfer packets TP are arranged extending over two pixels, and further, each readout gate of respective pixels is arranged so as to always come in contact with the respective transfer packets.

For example, for the adjacent Cy pixel P11 and G pixel P12, one transfer packet is arranged so as to come in contact with the transfer gate 111, which also serves as a readout gate of the Cy pixel P11, and the transfer gate 124, which also serves as a readout gate of the G pixel P12. Similarly, for the adjacent Cy pixel P13 and Mg pixel P14, the adjacent Cy pixel P15 and G pixel P16, and the adjacent Cy pixel P17 and Mg pixel P18, one transfer packet is arranged so as to come in contact with a transfer gate that also serves as a readout gate for both pixels. In this state, each of the light receiving section pixels is in a state where a signal charge obtained by a longer exposure time is accumulated.

Next, at time t1, when a readout pulse LcA1 of the first CCD driving signal ΦV1A and a readout pulse LcA4 of the fourth CCD driving signal ΦV4A are generated, accumulated charges of the Cy pixels P11, P13, P15 and P17, that is, signal charges accumulated during the accumulation time LT, as well as accumulated charges of the G pixel P12, the Mg pixel P14, the G pixel P16, and the Mg pixel P18, which are adjacent to the Cy pixels, that is, signal charges accumulated during the accumulation time LT, are read out to one transfer packet TP1 extending over these adjacent pixels.

That is, the accumulated charges Cy and G of the adjacent Cy pixel P11 and G pixel P12 are read out to the transfer packet TP1 extending over these pixels; the accumulated charges Cy and Mg of the adjacent Cy pixel P13 and Mg pixel P14 are read out to the transfer packet TP1 extending over these pixels; the accumulated charges Cy and G of the adjacent Cy pixel P15 and G pixel P16 are read out to the transfer packet TP1 extending over these pixels; and the accumulated charges Cy and Mg of the adjacent Cy pixel P17 and Mg pixel P18 are read out to the transfer packet TP1 extending over these pixels.

Subsequently, during timings tj2 to tj5, the signal charges read out to the respective transfer packets TP1 described above are transferred by one pixel in a vertical direction by the CCD driving signals ΦV1A, ΦV1B, ΦV2, ΦV3, ΦV4A and ΦV4B.

In this state, transfer packets TP1, in which signal charges that are an equivalent of two pixels obtained during a longer exposure time are added together and exist, and empty transfer packets TP2 are alternatively arranged in the vertical CCD 100.

Thereafter, awaiting period continues for awhile. During the waiting period, the photodiodes are repeatedly reset by the shutter pulses Sp until a timing tOFD that is earlier than a next timing for reading out the accumulated charges by a predetermined time (accumulation time), and signal charges obtained by the shorter exposure time are accumulated during this accumulation time ST.

Next, at time t5, when a readout pulse ScA1 of the first CCD driving signal ΦV1A and a readout pulse ScA4 of the fourth CCD driving signal V4A are generated, accumulated charges of the Cy pixels P11, P13, P15 and P17, (i.e., signal charges accumulated during the accumulation time ST) and accumulated charges of the G pixel P12, the Mg pixel P14, the G pixel P16, and the Mg pixel P18 (i.e., signal charges accumulated during the accumulation time ST), which are adjacent to the pixels P11, P13, P15 and P17, are read out to one transfer packet TP2 extending over these adjacent pixels.

Specifically, the accumulated charges Cy′ and G′ of the adjacent Cy pixel P11 and G pixel P12 are read out to the transfer packet TP2 extending over these pixels; the accumulated charges Cy′ and Mg′ of the adjacent Cy pixel P13 and Mg pixel P14 are read out to the transfer packet TP2 extending over these pixels; the accumulated charges Cy′ and G′ of the adjacent Cy pixel P15 and G pixel P16 are read out to the transfer packet TP2 extending over these pixels; and the accumulated charges Cy′ and Mg′ of the adjacent Cy pixel P17 and Mg pixel P18 are read out to the transfer packet TP2 extending over these pixels.

In this state, transfer packets TP1, in which signal charges that are an equivalent of two pixels obtained during a longer exposure time are added together and exist, and transfer packets TP2, in which signal charges that are an equivalent of two pixels obtained during a shorter exposure time are added together and exist, are alternatively arranged in the vertical CCD 100.

Subsequently, during time t6 to time t9, the signal charges read out to the transfer packets TP1 and TP2 described above are transferred by one pixel in a vertical direction by the CCD driving signals ΦV1A, ΦV1B, ΦV2, ΦV3, ΦV4A and ΦV4B. Further, the signal charges stored in these transfer packets are transferred to a horizontal CCD 100a and are transferred from the horizontal CCD 100a to a charge detection section 100b during a horizontal interval cycle, and further, these signal charges are converted into a voltage signal OS in the charge detection section 100b, the voltage signal OS being outputted.

As described above, two kinds of signal charges stored in different transfer packets, that is, signal charges obtained by a longer exposure and signal charges obtained by a shorter exposure, are successively read out and are synthesized by signal processing, thereby obtaining an image having a wide dynamic range.

As described above, according to the embodiment of the present invention, there is no time lag occurring between the period T1A and the period T4A, where the period T1A is from the time tOFD when the OFD shutter pulse ends to the time tΦV1A when the readout pulse ScA1 of the CCD driving signal ΦV1A ends, and where the period T4A is from the time tOFD when the OFD shutter pulse ends to the time tΦV4A when the readout ScA4 of the CCD driving signal ΦV4A ends.

Specifically, as shown in FIG. 3, an exposure time of a signal charge obtained by the gate readout by the CCD driving signal ΦV1A is T1A=tOFD−tΦv1A, and an exposure time of a signal charge obtained by the gate readout by the CCD driving signal ΦV4A is T4A=tOFD−tΦv4A. Since it is feasible to apply a readout pulse to readout gates of adjacent pixels simultaneously, exposure times for the respective light receiving section pixels are correctly and equally set when the readout gate is driven at the readout timing of 0=tΦv1A−tΦv4A. As a result, no matter how fast the OFD shutter speed is, the deterioration in an image due to the time lag of exposure times between adjacent pixels is avoided.

As described above, according to the present invention, a driving signal for a transfer gate is applied to the transfer gates in such a manner that adjacent pixels are included in a cycle of an arrangement pattern for transfer gates and accumulated charges in the adjacent pixels are simultaneously read out to a single transfer packet formed in a vertical transfer section, so that the time to read out the accumulated charges in the adjacent pixels to the transfer packets does not shift. Therefore, no matter how fast the OFD shutter speed is, the deterioration in an image due to the time lag of exposure times between adjacent pixels is avoided. As a result, even when a wide dynamic driving is performed for the solid-state image capturing device, such as a CCD image sensor, to obtain both a captured image obtained during a longer exposure time and a captured image obtained during a shorter exposure time, the deterioration in a captured image obtained during a shorter exposure, such as a color shift and line crawl, which becomes noticeable as the OFD shutter speed increases, is avoided. In addition, a good image signal having a wide dynamic range is easily obtained. Thereby, the performance of a digital still camera, a monitoring camera and the like is improved.

Although a case where a readout operation is performed twice within one field period is described in the embodiment described above, the readout operation can be performed three or more times within one field period.

Further, although a case is described where both accumulated charges obtained by a shorter exposure in the light receiving section and accumulated charges obtained by a longer exposure in the light receiving section are simultaneously read out between the adjacent pixels to the vertical CCD, the readout of the accumulated charges obtained by a longer exposure in the light receiving section to the vertical CCD does not necessarily performed simultaneously between the adjacent pixels.

### Embodiment 2

Further, although not specifically described in the embodiment described above, an electric information device will be described hereinafter.

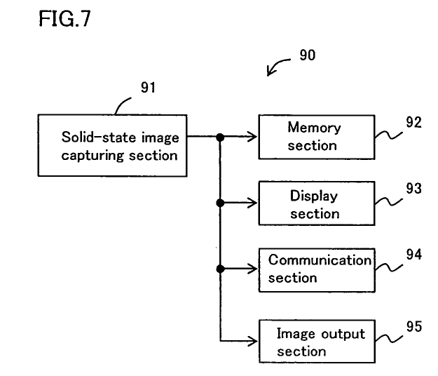

FIG. 7 is a block diagram showing an exemplary diagrammatic structure of an electric information device of Embodiment 2 of the present invention using the solid-state image capturing apparatus according to Embodiment 1 as an image capturing section.

The electric information device 90 of Embodiment 2 of the present invention shown in FIG. 7, such as a digital camera (e.g., digital video camera and digital still camera), an image input camera, a scanner, a facsimile machine and a camera-equipped cell phone device, has an image capturing section 91 using the solid-state image capturing apparatus according to Embodiment 1 described above as an image input device. The electronic information device according to the present invention includes at least any of: a memory section 92 (e.g., recording media) for data-recording a high-quality image data obtained by the solid-state image capturing device according to Embodiment 1 of the present invention as the image capturing section after a predetermined signal process is performed on the image dada for recording; a display section 93 (e.g., liquid crystal display device) for displaying this image data on a display screen (e.g., liquid crystal display screen) after a predetermined signal process is performed for display; a communication section 94 (e.g., transmitting and receiving device) for communicating this image data after a predetermined signal process is performed on the image data for communication; and an image output section 95 for printing (typing out) and outputting (printing out) this image data.

As described above, the present invention is exemplified by the use of its preferred embodiments. However, the present invention should not be interpreted solely based on the embodiments described above. It is understood that the scope of the present invention should be interpreted solely based on the claims. It is also understood that those skilled in the art can implement equivalent scope of technology, based on the description of the present invention and common knowledge from the description of the detailed preferred embodiments of the present invention. Furthermore, it is understood that any patent, any patent application and any references cited in the present specification should be incorporated by reference in the present specification in the same manner as the contents are specifically described therein.

### INDUSTRIAL APPLICABILITY

In the field of a solid-state image capturing device used for a camera-equipped cell phone device, a digital camera, a monitoring camera and the like, and particularly in the field of a solid-state image capturing device for successively reading out a signal charge obtained by a longer exposure and a signal charge obtained by a shorter exposure and synthesizing the signal charges by signal processing so as to obtain an image signal having a wide dynamic range and the driving method thereof, the present invention provides a solid-state image capturing device capable of easily obtaining a good image signal having a wide dynamic range without a picture deterioration upon a fast speed operation of the OFD shutter, and the driving method of the solid-state image capturing device.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A solid-state image capturing device for capturing a subject to generate and output an image signal, comprising:
a plurality of light receiving sections for performing a photoelectric conversion on incident light from the subject and accumulating signal charges obtained by the photoelectric conversion, the plurality of light receiving section being arranged in a matrix; and
a vertical transfer section including a plurality of transfer gates arranged along a row direction of the plurality of light receiving section, the vertical transfer section reading out the signal charges accumulated in the light receiving section and transferring the signal charges in a row direction,
wherein a predetermined number of transfer gates applied with different driving signals are arranged adjacent to respective pixel sections, so that each light receiving section and the predetermined number of transfer gates in the vertical transfer section form each pixel; and
wherein a driving signal for a transfer gate is applied to the transfer gates in such a manner that adjacent pixels are included in a cycle of an arrangement pattern for transfer gates and accumulated charges in the adjacent pixels are simultaneously read out to a single transfer packet formed in a vertical transfer section.

2. A solid-state image capturing device according to claim 1, further including a horizontal transfer section for receiving a signal charge transferred from the vertical transfer section in a row direction and outputting the signal charge from the vertical transfer section for every horizontal interval cycle.

3. A solid-state image capturing device according to claim 1 or 2, wherein two or more transfer packets are formed within a cycle of an arrangement pattern of the transfer gates of the vertical transfer section.

4. A solid-state image capturing device according to claim 3, wherein an operation to read out accumulated charges from adjacent pixels included in a cycle of the arrangement pattern of the transfer gates to the single transfer packet is performed twice within one field period.

5. A solid-state image capturing device according to claim 4, wherein at least an operation to read out accumulated charges obtained during a shorter exposure time between the operations to read out accumulated charges performed twice within the one field period is performed simultaneously between the adjacent pixels.

6. A solid-state image capturing device according to claim 3, wherein an operation to read out accumulated charges from adjacent pixels included in a cycle of the arrangement pattern of the transfer gates to the single transfer packet is performed three times or more within one field period.

7. A driving method of a solid-state image capturing device for capturing a subject to generate and output an image signal, the solid-state image capturing device comprising:
a plurality of light receiving section for performing a photoelectric conversion on incident light from the subject and accumulating signal charges obtained by the photoelectric conversion, the light receiving section being arranged in a matrix; and
a vertical transfer section including a plurality of transfer gates arranged along a row direction of the plurality of light receiving section, the vertical transfer section reading out the signal charges accumulated in the light receiving section and transferring the signal charges in a row direction,
wherein a predetermined number of transfer gates applied with different driving signals are arranged adjacent to respective pixel sections, so that each light receiving section and the predetermined number of transfer gates in the vertical transfer section form each pixel, and
the method comprising the step of applying a driving signal for a transfer gate to the transfer gates in such a manner that adjacent pixels in the solid-state image capturing device are included in a cycle of an arrangement pattern for transfer gates and accumulated charges in the adjacent pixels are simultaneously read out to a single transfer packet formed in a vertical transfer section.

8. A driving method of a solid-state image capturing device according to claim 7, wherein the solid-state image capturing device includes a horizontal transfer section for receiving a signal charge transferred from the vertical transfer section in a row direction and outputting the signal charge from the vertical transfer section for every horizontal interval cycle.

9. A driving method of a solid-state image capturing device according to claim 7 or 8, wherein two or more transfer packets are formed within a cycle of an arrangement pattern of the transfer gates of the vertical transfer section.

10. A driving method of a solid-state image capturing device according to claim 9, wherein an operation to read out accumulated charges from adjacent pixels included in a cycle of the arrangement pattern of the transfer gates to the single transfer packet is performed twice within one field period.

11. A driving method of a solid-state image capturing device according to claim 10, wherein at least an operation to read out accumulated charges obtained during a shorter exposure time between the operations to read out accumulated charges performed twice within the one field period is performed simultaneously between the adjacent pixels.

12. A driving method of a solid-state image capturing device according to claim 9, wherein an operation to read out accumulated charges from adjacent pixels included in a cycle of the arrangement pattern of the transfer gates to the single transfer packet is performed three times or more within one field period.

13. An electronic information device using the solid-state image capturing device according to claim 1 as an image capturing section.
